(19) United States
(12) Patent Application Publication
(10) Pub. No.: US 2007/0167070 A1
(43) Pub. Date: Jul. 19, 2007

(54) Head or bottom element of a component support

(76) Inventors: Eike Waltz, Aptos, CA (US); Werner Korber, Betzenstein (DE); Kurt Schaffer, Eckental (DE)

Correspondence Address: Pauley Petersen & Erickson, Suite 365, 2800 W. Higgins Road, Hoffman Estates, IL, 60195, US

(21) Appl. No.: 11/604,175

(22) Filed: Nov. 22, 2006

(30) Foreign Application Priority Data
Nov. 24, 2005 (DE) 10 2005 056 380.5

(51) Int. Cl. H01R 13/60

(52) U.S. Cl. 439/527

(57) ABSTRACT

A head or bottom element of a component support, having guide rails which are arranged side-by-side and aligned in an insertion direction for receiving a printed circuit board of a plug-in module. The guide rails are constituted or formed by one-piece guide elements of the head or bottom element. The head or bottom element includes an electrically conductive material at least over portions of its area. If the head or bottom element has a surface coating of electrically non-conductive material, at least partially in the area of the guide rail, it is then possible to achieve a dependable insulation of the printed circuit board from the head or bottom element in a simple and cost-effective manner.

### BACKGROUND OF THE INVENTION

1. Field of the Invention

This invention relates to a head or bottom element of a component support, having guide rails which are arranged side-by-side and aligned in an insertion direction for receiving a printed circuit board of a plug-in module, the guide rails are formed by one-piece guide elements of the head or bottom element, and the head or bottom element includes an electrically conductive material at least over portions of its area.

2. Discussion of Related Art

A head or bottom element of a component support is taught by European Patent Reference EP 1 144 579 A1. The guide rails are a part of the head or bottom elements. It is thus possible to considerably reduce the number of the structural parts of the component support. Also, the cost outlay for assembly is thus reduced. Known insertable separate guide rails, such as are required in connection with a component support in accordance with PCT International Application WO 00/2879, can be omitted.

A further advantage of the head or bottom elements is that with the arrangement of a cooling unit underneath the bottom element, cooling air can pass through the bottom element and can cool the plug-in modules.

The advantages of the known head or bottom elements have to be paid for because of the manufacture being very complicated and expensive. The guide rails include a bottom and two lateral walls and thus cannot be produced in a simple bending and punching process because of their bulges and contact points with the printed circuit boards. It is occasionally required for the printed circuit boards of the plug-in modules to be electrically insulated from the guide rails. Thus, plastic supports which receive the edge of the printed circuit boards are inserted into the guide rails. The plastic supports increase the cost outlay for parts and assembly.

### SUMMARY OF THE INVENTION

It is one object of this invention to provide a head or bottom element for a component support of the type mentioned above so that the printed circuit board of a plug-in module can be electrically insulated against the head or bottom element in a simple manner.

In accordance with this invention, the object is attained if the head or bottom element has a surface coating of electrically non-conductive material, at least partially in the area of or near the guide rail.

It is thus possible with the surface coating to electrically insulate head or bottom elements selectively in a defined manner. The coating can be conveniently applied. A further advantage is that no additional assembly steps need to be taken by the user for creating the insulation. Also, the surface coating can have a reduced layer thickness, so that little assembly space or air circulation space is lost.

In one embodiment of this invention, the surface coating is incorporated into the material of the surface of the bottom element and/or the head element, wherein the surface coating can be designed as a powder coating or whirl-sintered coating, for example. This type of coating permanently assures a dependable electrical insulation.

In one embodiment of this invention, the guide elements are formed by respectively two rows of several guide strips per guide rail, which extend in an insertion direction and are spaced apart, and are punched out of a plate-shaped head or bottom element and are beveled and protrude in the direction of the underside of the head element or the top of the bottom element. The spacing of the guide strips of the guide rails is matched to the thickness of the printed circuit boards of the plug-in modules. The head or bottom elements form guide tracks between the rows of guide strips of the guide rails for the printed circuit boards of the plug-in modules.

The guide strips as guide elements can be produced in a simple punching and bending process from a plate-shaped base element. Thus the guide strips do not exert any, or no strong counter-forces, so that the plug-in modules can be easily inserted.

So that the printed circuit boards do not get hooked while being inserted or removed, according to this invention, the distance between the guide strips slightly increases in the direction toward the free end edges of the guide strips. The guide track between the guide strips assures a dependable support and guidance for the printed circuit board.

With such an arrangement it is possible to achieve a dependable insulation such as if the guide tracks and the guide strips, on their sides facing the guide tracks have the surface coating.

So that venting and cooling of the plug-in modules from the direction of the underside can be maintained, in another embodiment, the head or bottom element can be embodied in the form of a perforated sheet by perforations outside of the guide tracks and guide strips. Preferably, the perforations are made in the course of the same punching process as the one for the guide strips.

If the sides of the plate-shaped head or bottom element are reinforced by beveled lateral walls, it is possible to achieve sufficient stability with a reduced wall thickness of the head or bottom element.

If also the lateral walls are clear of the surface coating, at least in some areas, it is possible to connect components of the component support, which are connected to the lateral walls, for example lateral element, to a uniform electrical potential by the conductive areas.

Also, it is possible to satisfy the requirements of EMC with these areas. If a head element and a bottom element with guide rails is provided for the component support, it is possible to reduce the cost outlay for the two elements, particularly if the head or bottom elements are designed identical and are installed in the component support rotated by 180°.

A particularly good guidance and contacting of the printed circuit board in the guide rail is achieved if the guide elements of the guide tracks of a head or bottom element are arranged in pairs opposite each other in a component support.

In one embodiment, the first pair of the guide strips of a guide track facing the insertion side extends are in the form of insertion strips with their sides facing each other at an acute angle, which opens in a direction toward the insertion side. Thus, the insertion strips of the guide tracks form an insertion receiver having an insertion slope, a sort of forced position and introduction into the guide rail is achieved when placing the plug-in module against the start of the guide rail. This can simplify equipping the component support.

The head or bottom element is preferably made as a punched and bent element from a sheet steel blank. It can then be easily produced and can also be used for contacting and grounding, or shielding the plug-in modules.

Contacting of the printed circuit board of the plug-in module can be achieved if a spring element, which projects with a spring leaf into the guide rail, can be attached to one of the insertion strips. Thus, the attachment process is simplified because the spring element has an attachment hood matched to a cross section of the insertion element.

Fixing the spring element in place on the insertion strip can be achieved so that a U-shaped plug-in element adjoins the attachment hood of the spring element, which has two legs with snap-in flaps. The plug-in element can be snapped into the punched-out receiver of the head or bottom element, which is created or formed when the insertion strip is punched out and beveled. The snap-in and attachment process is clearly assured without tilting of the spring element because the plug-in element ends in an angled off end stop, which limits an insertion movement of the plug-in element and the attachment movement of the attachment hood. Thus the end section of the plug-in element rests against the underside of the head element or top of the bottom element, depending on which element the spring element is fixed in place.

The spring leaf projecting into the guide rail does not complicate pulling out the plug-in module if the spring leaf forms or constitutes a direct contact point with the printed circuit board of the plug-in module, and downstream of the direct contact point the spring leaf makes a transition into an end section, which forms or constitutes a tightening slope. The pull-out slope assures that the end section of the spring leaf cannot become hooked on the guide strips.

### BRIEF DESCRIPTION OF THE DRAWINGS

This invention is explained in greater detail in view of an exemplary embodiment represented in the drawings, wherein:

FIG. 1 shows a schematic structure of a known component support, in a perspective plan view;

FIG. 2 shows a bottom element, which can be used for a component support, in a perspective view from above;

FIG. 3 shows an end area X of the bottom element in accordance with FIG. 2, in an enlarged perspective view;

FIG. 4 shows a corner area X in a view from above;

FIG. 5 shows a spring element for attaching an insertion strip of a guide rail;

FIG. 6 shows the spring element in accordance with FIG. 5, in a view on a front face;

FIG. 7 is a perspective partial view from above, showing a spring element attached to an insertion strip and snapped together with a bottom element;

FIG. 8 shows a view from above on an area of a bottom element represented in FIG. 7;

FIG. 9 shows a partial plan view of a spring element attached to an insertion strip and snapped together with the bottom element;

FIG. 10 shows a component support in a perspective plan view;

FIG. 11 shows an enlarged portion of a left bottom side of the component support in accordance with FIG. 10; and

FIG. 12 shows a vertical section view taken through the component support in accordance with FIG. 10.

### DETAILED DESCRIPTION OF THE INVENTION

The schematic plan view in accordance with FIG. 1 shows a prior art component support with two lateral walls 1 which can be used to adjust the height. The head element 2 and the bottom element 3 complete the component support and determine its width. As shown in FIG. 1, the head element 2 and the bottom element 3 represent one-piece elements, which have several guide rails arranged side-by-side and aligned in an insertion direction. A surrounding frame connects the guide rails at the front and at the rear of the component support. In this case, the head element 2 and the bottom element 3 can be identically configured, embodied or formed and inserted into the component support and rotated by 180°, wherein the guide rails in the head element 2 are open toward the bottom, and in the bottom element 3 open toward the top for being able to receive and guide a printed circuit board of a plug-in module. As mentioned, head and bottom elements embodied in this way cannot be produced simply and cost-effectively because of the structural design of the guide rails.

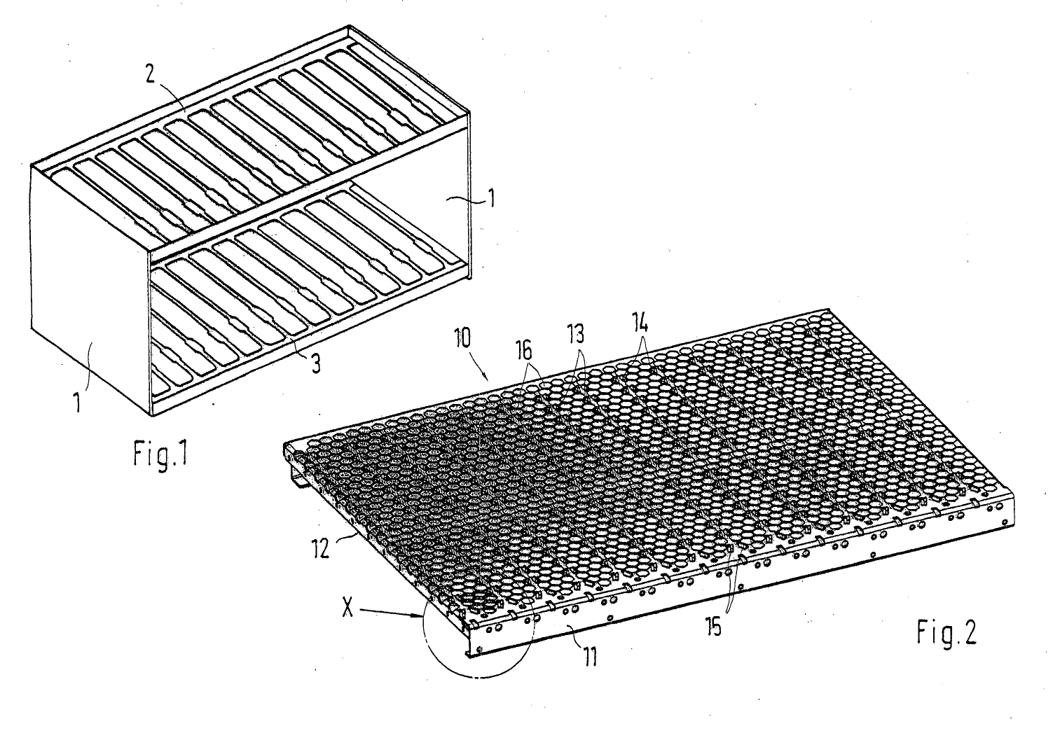

To avoid this disadvantage, the component support according to this invention uses head or bottom elements 10 in accordance with FIG. 2, which can be produced in the form of simple punched and bent elements in one simple, uncomplicated process, because for a practical purposes the essential bending processes can also be performed only in the punching direction.

For reasons of stability, the plate-shaped head or bottom element 10, which has many perforations 16, is reinforced by beveled lateral walls 11 and 12 embodied as edges.

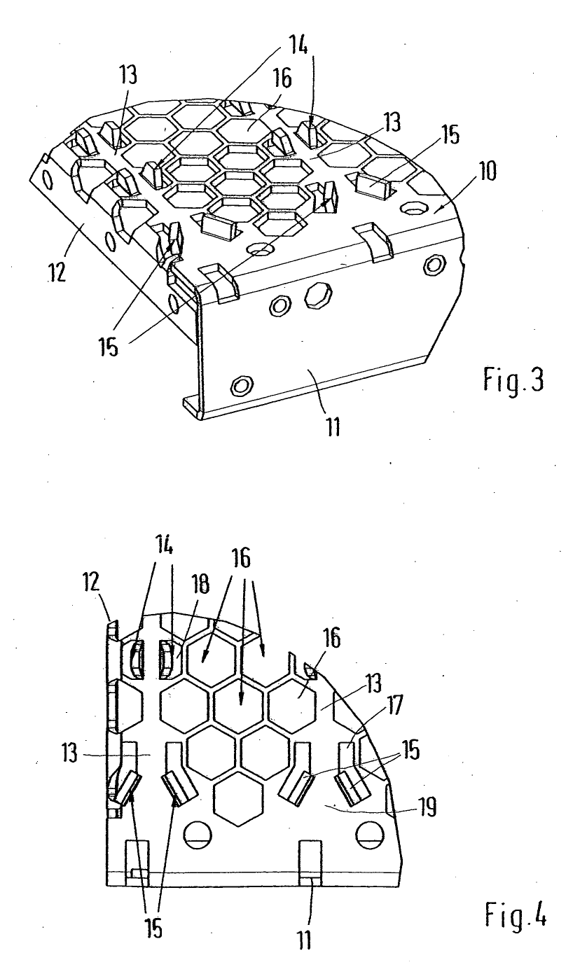

As shown in the enlarged plan views in FIGS. 3 and 4, guide tracks 13 are formed with guide strips 14 set on edge as the guide rails, which are aligned from the front to the rear of the bottom element 10. A pair of insertion strips 15 on the front forms one insertion receiver per guide rail. The head or bottom element 10 has perforations 16 outside of the guide tracks 13.

As shown in FIGS. 3 and 4, there are two rows of guide strips 14 per guide strip, which are simply punched out and beveled up. In this case, a recess 18 remains on a side of the guide strip 14. The perforations 16 are regular hexagons and are connected with each other in a honeycomb-like manner, so that a large portion of the surface of the head and bottom elements 10 between the closed guide tracks 13 between the two rows of guide strips 14 per guide rail remains open and can be used for ventilation and/or cooling of the plug-in modules in the component support.

The perforations 18 are also used for ventilation and/or cooling. Accordingly, air can circulate between the top and bottom of the head or bottom element 10 through the perforations 16 and the recesses 18. Waste heat from the interior of the component support is picked up and carried off in the process.

FIGS. 3 and 4 show the guide strips 14 of the two rows of a guide rail located opposite each other in pairs in the insertion direction and slightly inclined so that the distance beginning at the guide track 13 toward the free end of the guide strips 14 increases slightly. In the area of or near the guide track 13, this distance is matched to the thickness of the printed circuit board of the plug-in module.

Thus the insertion friction on the plug-in modules is kept low. Also, catching of the plug-in module on the guide rails 14 is prevented.

On the insertion side, a pair of insertion strips 15 forms an insertion opening as a sort of insertion slope. The pair of insertion strips 15 at the start of the guide rails is punched out obliquely in a direction of their outsides in addition to its slope, the same as the guide strips 14, so that the lateral areas facing each other are at an acute angle with respect to each other in the insertion direction. Thus, the distance is greater at the front than at the end, so that the insertion receiver 19 which narrows is formed. At an end, the insertion receiver 19 changes to the thickness of the printed circuit board of the plug-in module. The insertion strips 15 are punched out of the head or bottom element 10, wherein the double inclined position of the insertion strips 15 requires a larger punched-out receptacle 17, such as shown in FIG. 4.

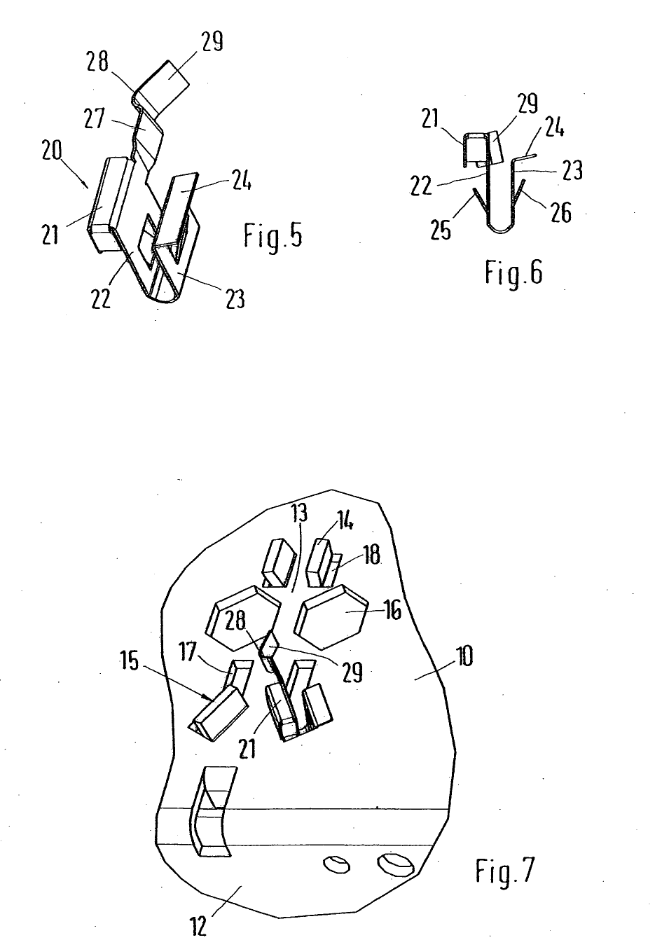

FIGS. 5-9 show one example of how the head or bottom element 10 provides contacting between the printed circuit boards of the plug-in modules and the head or bottom element 10 by a spring element 20 in accordance with FIG. 5, and how the spring element 20 can be connected with the insertion strip 15.

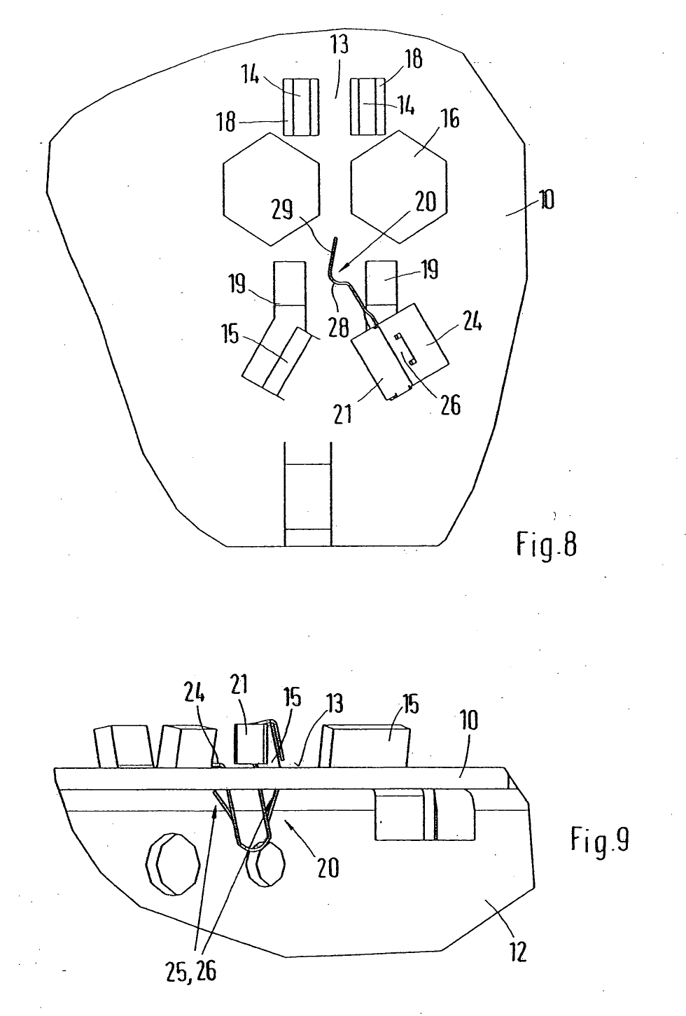

The spring element 20 has an attachment hood 21, which can be pushed on the insertion strip 15 of a guide rail. A U-shaped plug-in element with legs 22 and 23 adjoins the one longitudinal wall of the attachment hood 21, as shown in FIG. 6, and snaps into the punched-out receptacle 17 of the insertion strip 15, as shown in FIG. 9. Here, the snap-in flaps 25 and 26, punched out of the legs 22 and 23, are supported on the top of the head element or the underside of the bottom element 10. The end section 24 of the leg 23 limits the insertion and snap-in movement, so that the spring element 20 is seated securely on the insertion strip 15 and cannot be tilted. A spring leaf 27 is attached to the attachment hood 21 of the spring element 20, which projects into the guide rail in the same manner as the contact spring, as shown in FIGS. 7 and 8. In this case a direct contact point 28 formed on the spring leaf 27 projects the farthest into the guide rail.

When a printed circuit board of a plug-in module is inserted, the spring leaf 27 is deflected and only the direct contact point 28 provides an electrical connection. The end section 29 of the spring leaf 27 is located at a distance from the printed circuit board to form a pull-out slope, so that when pulled out it cannot become hooked on the plug-in module. The spring element 20 can be variably designed so that it can be attached to either the left or the right insertion strip 15 of a guide rail.

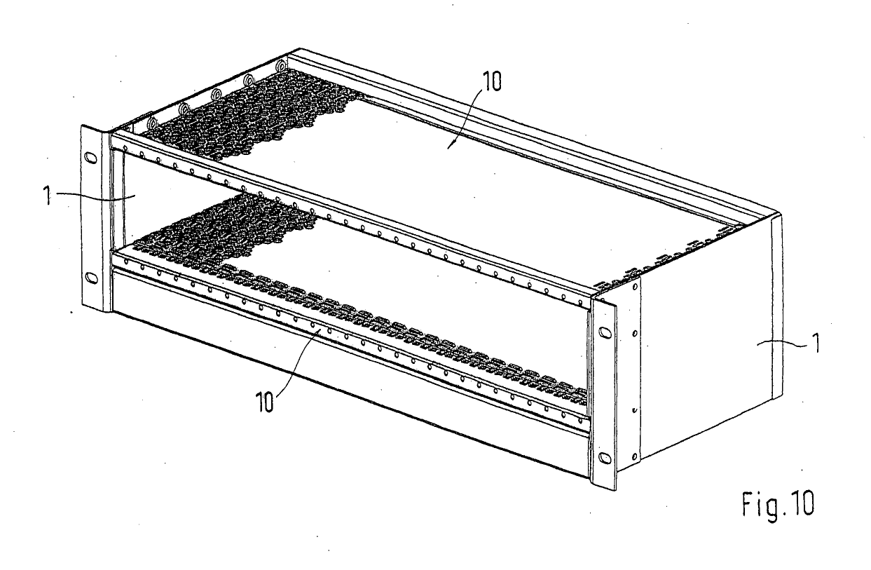

FIG. 10 shows a component support with two lateral elements 1 and a head element and a bottom element 10.

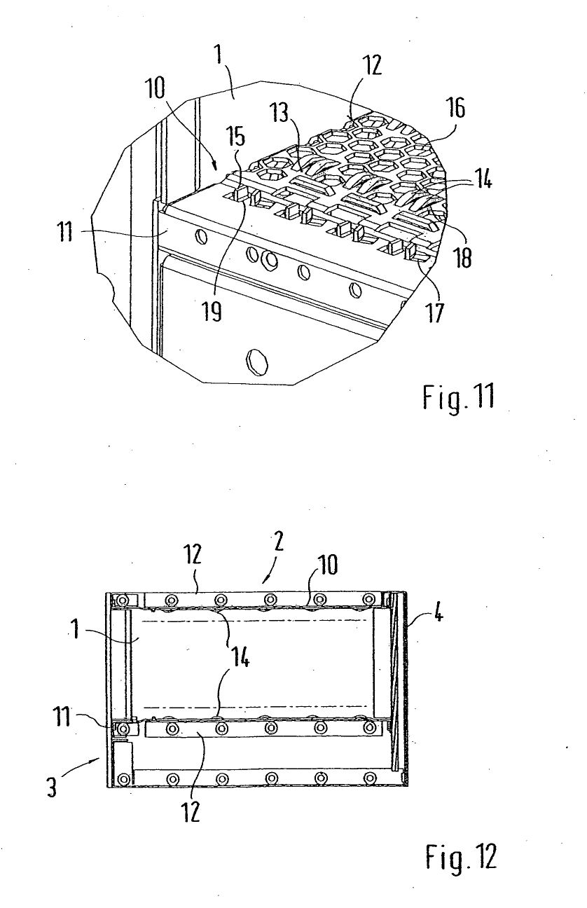

The design of the bottom element 10, which can be identical with the head element 10, is illustrated in FIG. 11.

The bottom element 10 can be designed similar to those shown in FIGS. 2-9. One difference is in the design of the guide strips 14. As FIG. 11 shows, the guide tracks 13 are delimited by bridge-like guide strips 14. In the connecting area with the bottom element 10, the guide strips 14 have run-up slopes extending at a shallow angle in a direction of the guide tracks 13. The run-up slopes are connected with a bridge section. The run-up slopes dependably prevent the hooking of the printed circuit board when it is inserted or removed.

In accordance with this invention, the head and bottom elements 10 in accordance with FIGS. 1 to 12 are made of sheet steel with a surface coating of an electrically insulating material.

It is, for example, possible to use a powdered lacquer coating. Here the surface coating provides the areas of the head or bottom elements 10 required for electrical contact free. For example, the lateral walls 11 and 12 can be uncoated.

On them, the lateral walls 1, a rear wall 4, or front components can be connected to a uniform electrical potential, or an EMC contact can be provided.

If required, the insertion strips 15 can also be maintained free of coating, at least in parts, in order to make possible contacting of the spring element 20.

German Patent Reference 10 2005 056 380.5, the priority document corresponding to this invention, and its teachings are incorporated, by reference, into this specification.

What is claimed is:

1. A head element or a bottom element of a component support, having guide rails arranged side-by-side and aligned in an insertion direction for receiving a printed circuit board of a plug-in module, wherein the guide rails are formed by one-piece guide elements of the head element or the bottom element, and the head element or the bottom element has an electrically conductive material at least over a portion of an area, the head element or the bottom element comprising:
the head element or the bottom element (10) having a surface coating of electrically non-conductive material, at least partially near one of the guide rails.

2. The head element or the bottom element in accordance with claim 1, wherein the surface coating is incorporated into the material of the surface of at least one of the bottom element and the head element (10).

3. The head element or the bottom element in accordance with claim 2, wherein the surface coating is one of a powder coating and a whirl-sintered coating.

4. The head element or the bottom element in accordance with claim 3, wherein the guide elements are formed by respectively two rows of guide strips (14) per each of the guide rails, which extend in the insertion direction and are spaced apart, are punched out of the head element or the bottom element (10) which is plate shaped, and are beveled and protrude in a direction of the underside of the head element or a top of the bottom element, a spacing of the guide strips (14) of the guide rails matched to a thickness of the printed circuit boards of the plug-in modules, and the head element or the bottom element (10) forms guide tracks (13) between the rows of guide strips (14) of the guide rails for the printed circuit boards of the plug-in modules.

5. The head element or the bottom element in accordance with claim 4, wherein the guide tracks (13) and the guide strips (14) on sides facing the guide tracks (13) have the surface coating.

6. The head element or the bottom element in accordance with claim 5, wherein a distance between the guide strips (13) slightly increases in a direction toward end edges of the guide strips (14).

7. The head element or the bottom element in accordance with claim 6, wherein the head element or the bottom element (10) is formed as a perforated sheet by perforations (16) outside of the guide tracks (13) and the guide strips (14).

8. The head element or the bottom element in accordance with claim 7, wherein sides of the plate-shaped head element or the bottom element (10) are reinforced by beveled lateral walls (11, 12).

9. The head element or the bottom element in accordance with claim 8, wherein the lateral walls (11, 12) are clear of the surface coating, at least in some areas.

10. The head element or the bottom element in accordance with claim 9, wherein the head element and the bottom element (10) are designed identical and are installed in the component support rotated by 180°.

11. The head element or the bottom element in accordance with claim 10, wherein the guide elements (14) of the guide tracks (13) are arranged in pairs opposite each other.

12. The head element or the bottom element in accordance with claim 11, wherein a first pair of the guide strips of a guide track (13) facing the insertion side extend as insertion strips (15), and the insertion strips (15) extend with sides facing each other at an acute angle, which opens in the direction toward the insertion side, and the insertion strips (15) of the guide tracks (13) form an insertion receiver (19) having an insertion slope.

13. The head element or the bottom element in accordance with claim 12, wherein the head element or the bottom element (10) is made as a punched and bent element from a sheet steel blank.

14. The head element or the bottom element in accordance with claim 13, wherein a spring element (20) projects with a spring leaf (27) into the guide rail and can be attached to one of the insertion strips (15).

15. The head element or the bottom element in accordance with claim 14, wherein the spring element (20) has an attachment hood (21) matched to a cross section of the insertion element (25).

16. The head element or the bottom element in accordance with claim 15, wherein a U-shaped plug-in element adjoins the attachment hood (21) of the spring element (20) which has two legs (22, 23) with snap-in flaps (25, 26), and the plug-in element is snappable into the punched-out receiver (17) of the head element or the bottom element (10) and is formed when the insertion strip is punched out and beveled.

17. The head element or the bottom element in accordance with claim 16, wherein the plug-in element terminates in an angled off end stop (24), which limits an insertion movement of the plug-in element and the attachment movement of the attachment hood (21).

18. The head element or the bottom element in accordance with claim 17, wherein the spring leaf (27) forms a direct contact point (28) with the printed circuit board of the plug-in module, and downstream of the direct contact point (28) the spring leaf (27) transitions into an end section (29) which forms a tightening slope.

19. The head element or the bottom element in accordance with claim 1, wherein the guide elements are formed by respectively two rows of guide strips (14) per each of the guide rails, which extend in an insertion direction and are spaced apart, are punched out of the head element or the bottom element (10) which is plate shaped, and are beveled and protrude in a direction of an underside of the head element or a top of the bottom element, a spacing of the guide strips (14) of the guide rails matched to a thickness of the printed circuit boards of the plug-in modules, and the head element or the bottom element (10) forms guide tracks (13) between the rows of guide strips (14) of the guide rails for the printed circuit boards of the plug-in modules.

20. The head element or the bottom element in accordance with claim 4, wherein a distance between the guide strips (13) slightly increases in a direction toward end edges of the guide strips (14).

21. The head element or the bottom element in accordance with claim 4, wherein the head element or the bottom element (10) is formed as a perforated sheet by perforations (16) outside of the guide tracks (13) and the guide strips (14).

22. The head element or the bottom element in accordance with claim 1, wherein sides of the plate-shaped head element or the bottom element (10) are reinforced by beveled lateral walls (11, 12).

23. The head element or the bottom element in accordance with claim 1, wherein the head element and the bottom element (10) are designed identical and are installed in the component support rotated by 180°.

24. The head element or the bottom element in accordance with claim 1, wherein the guide elements (14) of the guide tracks (13) are arranged in pairs opposite each other.

25. The head element or the bottom element in accordance with claim 4, wherein a first pair of the guide strips of a guide track (13) facing the insertion side extend as insertion strips (15), and the insertion strips (15) extend with sides facing each other at an acute angle, which opens in the direction toward the insertion side, and the insertion strips (15) of the guide tracks (13) form an insertion receiver (19) having an insertion slope.

26. The head element or the bottom element in accordance with claim 1, wherein the head element or the bottom element (10) is made as a punched and bent element from a sheet steel blank.

27. The head element or the bottom element in accordance with claim 1, wherein a spring element (20) projects with a spring leaf (27) into the guide rail and can be attached to one of the insertion strips (15).

28. The head element or the bottom element in accordance with claim 14, wherein the spring leaf (27) forms a direct contact point (28) with the printed circuit board of the plug-in module, and downstream of the direct contact point (28) the spring leaf (27) transitions into an end section (29) which forms a tightening slope.
